(19) United States
(12) Patent Application Publication
(10) Pub. No.: US 2009/0055262 A1
(43) Pub. Date: Feb. 26, 2009

(54) System and method for advertising testimonial services

(76) Inventor: Terri Coulter, Virginia Beach, VA (US)

Correspondence Address: Bradley D. Goldizen, One Columbus Center, Ste. 665, Virginia Beach, VA, 23462, US

(21) Appl. No.: 11/895,115

(22) Filed: Aug. 23, 2007

(51) Int. Cl. G06Q 30/00

(52) U.S. Cl. 705/14

(57) ABSTRACT

A system and method of providing cost effective litigation support through the use of trained and licensed medical professionals, other than medical doctors, includes building at least one database of information that includes credentials of the medical professionals including schooling and work experiences. The database includes contact information. Work experiences include any former expert testimony provided in litigation. Information from the database is marketed to litigants. A system for implementing the method may further include a processor and a second database of licensed attorneys who litigate certain legal issues. Data stored in the first database is marketed and sold to litigants in the second database.

There are no related applications.

This application did not receive any federally research and/or development funding.

### FIELD OF THE INVENTION

Generally, the present invention relates to a system and method for marketing medical testimony services to litigants at a reduced price. More particularly, the invention relates to a method for building a database of qualified medical professions whom are not medical doctors. In one instance, the method relates to building a database of licensed pharmacists in a particular State or Commonwealth. The licensed pharmacists desire to provide pharmaceutical expertise as testimony for litigation cases such as drug interaction cases and thereafter become participants whose credentials and experiences are marketed to litigants. The present invention may be implemented in an online embodiment or in an off-line embodiment.

### BACKGROUND OF THE INVENTION

Medical doctors are often called upon to provide medical testimony during litigation proceedings having issues such as product liability and drug reaction and/or interaction. Prices for obtaining expert testimony from a medical doctor typically range from five hundred dollars ($500.00) per hour for services rendered and upwards. Often individuals more qualified than the medical doctor are overlooked when litigating product liability and drug reaction/interaction claims.

Previously, for instance, a litigant desiring to bring a product liability or drug interaction/reaction case against a manufacturer of a prescription drug usually called upon the testimonial ability of a medical doctor. However, it should be recognized that in this type of litigation, a medical doctor is not the most qualified medical expert. A pharmacist may be the most appropriate individual to testify in drug interaction/reaction cases because they are skilled in chemistry, pharmacology and pharmaceutics, which reason the effects of various chemicals and drugs on the body. Moreover, the billing rate for a pharmacist is cheaper than that of a medical doctor. Likewise, other trained medical professionals may be qualified to provide expert testimony in litigation proceedings at cheaper rates than those of a medical doctor.

Expert testimony must be provided when litigating drug interaction and/or reaction cases. Many aggrieved parties cannot effectively litigate their claims because securing the testimony of an expert such as a medical doctor is cost prohibitive. Thus, many claims are simply abandoned and the injured parties live with the damage created by such products.

Thus, there is a great need for a more cost effective method of litigating against large pharmaceutical companies or other companies that have vast financial resources. The present invention aims to level the playing field in the litigation arena by reducing the cost for providing expert testimony in many product liability and drug interaction and/or reaction claims.

The present invention aims to reduce the cost associated with litigating against a large pharmaceutical company, a large incorporated company or wealthier individuals by providing a database of qualified individuals who are not doctors but still can provide expert testimony for the litigant.

There are two distinct advantages in the present invention. A first advantage is that the pharmacists or other medically trained individuals will cost the litigator and ultimately the litigant less thereby reducing the costs of litigating a case. Another benefit is that in drug interaction cases and other specialized areas relating to reactions created by drugs, the pharmacists are more qualified to answer these questions than a medical doctor.

### SUMMARY OF THE INVENTION

The present invention is a business process that markets particular consulting qualifications of medical experts, such as pharmacists, to other legal professionals, such as lawyers or others in need of the medical expert's consulting abilities. The medical experts are not medical doctors and have cheaper hourly rates for performing testimonial services to litigants in comparison to doctors. In instances where litigation is based on drug interaction cases, the pharmacists are more qualified to offer expert testimony than a medical doctor.

The process includes building a database of qualified individuals licensed by a particular body. In an online application, the database may be used to publish an expert's credentials on-line for use in litigating pharmacological or pharmaceutical claims. The expert's credentials will include the holding of special licenses to practice a particular profession or trade. Issuance of these licenses to practice the particular profession is regulated by the States or their respective representatives, such as the Virginia Board of Pharmacy. The database also includes point-of-contact information such as email address, postal address, telephone and facsimile numbers.

The process further includes identifying participants who hold the license to practice in a particular profession. This could be through any means of communicating a request for a list of all licensed individuals and receiving the requested information. This could also be through requesting or copying public records via the internet. The process also includes storing this information in a searchable database that can quickly provide litigation support to an attorney. The particular specific example of the process would include a database of each state, commonwealth or U.S. territory and listing all the licensed pharmacists, current standing or status in each state or commonwealth and their respective point-of-contact information.

In one instance, the process is applied to pharmacists. As identified by the U.S. Department of Labor, pharmacists distribute drugs prescribed by physicians and other health practitioners and provide information to patients about medications and their use. They advise physicians and other health practitioners on the selection, dosages, interactions, and side effects of medications. Pharmacists also monitor the health and progress of patients in response to drug therapy to ensure the safe and effective use of medication. Pharmacists must understand the use, clinical effects, and composition of drugs, including their chemical, biological, and physical properties. These skills are useful when litigating drug interaction or drug reaction cases for product liability claims. The expert's credentials are packaged together so that litigators can choose among those qualified individuals.

In one specific instance, the steps in the process include: 1. Identifying individuals who are qualified to participate in the marketing process. This includes anyone who has a license to practice pharmacy in a particular state and is in good standing with the particular governing authority; 2. Contacting the qualified individuals and querying whether they would like to participate in the marketing; 3. Listing those qualified individuals who have chosen to become participants in a database that is limited to litigants; 4. Identifying litigants and individuals who are licensed to practice law in a particular jurisdiction; and, 5. Marketing the qualified participants to the litigants or attorneys. It should be noted that other medical professionals may be included as the identified and qualified individuals.

In an offline embodiment, a database is built and marketed to end users who are litigants. In an online embodiment, the system includes a central terminal or database having the expert's credentials and limited access to participating litigants. Access to the database will be restricted to the qualified individuals being listed therein and paying participants that view the qualified individual's credentials. Remote user terminals allow a listed or paying participant to review the information in a particular database. This embodiment of the process also includes a medium having the particular process steps listed above.

It is an object of the invention to provide a cost-effective method of marketing qualified individuals to litigants to reduce the overall costs associated with litigating a claim.

It is a further object of the invention to build a database of qualified individuals whose schooling and experiences are used in supporting expert testimony in a court proceeding.

It is an additional object of the invention to build a database of experts whose hourly billing rate is cheaper than that of a medical doctor without compromising the ability to provide expert testimony.

The above and further objects, details and advantages of the invention will become apparent from the following detailed description, when read in conjunction with the accompanying drawings.

### BRIEF DESCRIPTION OF THE DRAWINGS

FIG. 1A is a flowchart of the method for implementing the invention in a first embodiment. FIG. 1B is a flowchart of the method for implementing the invention in a second embodiment.

FIG. 2 shows the steps for building the first database and implementing the invention.

FIG. 3 is a schematic view of an online embodiment.

FIG. 4 is a schematic view of an off-line embodiment.

FIG. 5 is a first database and shows an exemplary of information contained therein.

FIG. 6 is a second database and shows an exemplary of information contained therein.

### DETAILED DESCRIPTION OF THE INVENTION

The embodiments of the invention and the various features and advantageous details thereof are more fully explained with reference to the non-limiting embodiments and examples that are described and/or illustrated in the accompanying drawings and set forth in the following description. It should be noted that the features illustrated in the drawings are not necessarily drawn to scale, and the features of one embodiment may be employed with the other embodiments as the skilled artisan recognizes, even if not explicitly stated herein. Descriptions of well-known components and techniques may be omitted to avoid obscuring the invention. The examples used herein are intended merely to facilitate an understanding of ways in which the invention may be practiced and to further enable those skilled in the art to practice the invention. Accordingly, the examples and embodiments set forth herein should not be construed as limiting the scope of the invention, which is defined by the appended claims. Moreover, it is noted that like reference numerals represent similar parts throughout the several views of the drawings.

The following is a list of the terms and definitions used in the present application. The respective definitions define what the term comprises for purposes of this application and unless otherwise expressly indicated such terms as used in the present application shall have the indicated meaning, whether bolded, capitalized or otherwise highlighted or not. Likewise singular words should be broadly construed to include a plurality as well.

The term “litigant” means an attorney licensed in a particular jurisdiction or an aggrieved party who is interested in litigating or is currently litigating a claim against another party and in need of expert medical testimony.

“Qualified individual” is a professional or an individual who is not a medical doctor and who is recognized as a qualified medical expert by a pharmacy board or other appropriate authority that governs the licensing of such professions as pharmacists, physicians assistants, nurse practitioners, nurses or other medically trained individuals. These qualified individuals are invited to participate in litigation and to provide expert testimony relating to previous schooling and work experiences. Not all qualified individuals may desire to participate in the litigation. Those who decline an offer to participate are not listed in the first database. An invitation to participate is extended to the qualified individual along with certain terms and conditions that are set forth by the compiler.

A “database” or a “first database” is a compilation of data relating to a qualified individual's credentials including degrees earned or bestowed upon the qualified individual, point-of-contact information and litigation testimony history. A “Second Database” is a compilation of data relating to a litigant.

“Participating qualified individual” is a participant who has affirmatively requested that her/his qualifications be listed in the first database. The participating qualified individual agrees to the terms and conditions that are set for by the compiler. These terms and conditions typically include length of term that the participating qualified individual will have their name listed in the first database, an agreed upon hourly rate for services rendered that the participant will receive, a nondisclosure and non-compete clauses, as well as any termination clauses that sever the independent contacting relationship between the participant and the compiler.

“Drug interaction” is an adverse reaction between two different drugs or between a medication and a disease state or condition. Drug Interactions occur in many litigates and may be attributed to a product liability, negligence, counterfeit or fraudulent marketing claim.

“Drug reaction” is an allergic reaction, adverse response or side effect to the use of a drug.

“Drug” or “drugs” means prescription and nonprescription medications for treating diseases or certain conditions or symptoms and should be interpreted broadly to include any delivery medium including pills, capsules, mists, sprays, liquids, creams, lotions, ointments, pastes, powders and gels.

“Product liability” is the responsibility of a manufacturer for injury or loss caused by its product.

“Online” means operating under the direct control of, or connected to a main computer via the internet or otherwise connected by a computer to one or more other computers or networks through an electronic information service or the Internet including transmitting electronic information over telecommunications means.

“Off-line” means operating independently of, or disconnected from, an associated computer including through use of postal mailings, telephone calls, and facsimile transmissions.

“Printed advertisements” includes any type of advertisement that comprises print and may include mass media advertisements such as bill boards, newspapers, periodicals, magazines, printing on the sides of automobiles or the like.

The term “professional” typically means someone requiring advanced knowledge in a field of science or learning customarily acquired by a prolonged course of specialized intellectual instruction, prior to entry in a job.

The phrase “field of science or learning” includes the traditional professions of medicine, excluding doctors, but including pharmacy and other similar occupations that have a recognized professional status as distinguished from the mechanical arts or skilled trades where in some instances the knowledge is of a fairly advanced type, but is not in a field of science or learning. Medical matters are associated with the providing of these traditional professions of medicine.

The phrase “customarily acquired by a prolonged course of specialized intellectual instruction” means a profession where specialized academic training is a standard prerequisite for entrance into the profession. The evidence that a professional meets this requirement is possession of the appropriate academic degree and may include a licensing procedure that includes a testing process.

“Registered or certified medical technologists” are qualified individuals who have successfully completed three academic years of pre-professional study in an accredited college or university plus a fourth year of professional course work in a school of medical technology approved by the Council of Medical Education of the American Medical Association.

“Nurses” include qualified individuals who are Registered Nurses who are recognized by the appropriate State examining board generally meet the duties requirements for the learned profession of a nurse.

“Dental hygienists” are qualified individuals who have successfully completed four academic years of pre-professional and professional study in an accredited college or university approved by the Commission on Accreditation of Dental and Dental Auxiliary Educational Programs of the American Dental Association.

“Physician assistants” are qualified individuals who have successfully completed four academic years of pre-professional and professional study, including graduation from a physician assistant program accredited by the Accreditation Review Commission on Education for the Physician Assistant, and who are certified by the National Commission on Certification of Physician Assistants.

The term “compiler” means anyone who compiles a list of information relating to the professionals into a database for marketing these qualifications to litigants who are litigating drug interaction/reaction causes of actions in court systems. The compilation process may occur in a fixed tangible copy of handwritten notes from which a participant's name is chosen to provide expert testimony in a court case. Otherwise, the compiler may utilize a computer for compiling the data in an appropriate database for carrying out the invention. In order to be listed in the first database, a qualified individual must agree to comply with the terms and conditions set forth by the compiler. Namely, an independent contractor relationship is created between the compiler and the professionals listed in the first database, whereby the professionals agree to provide expert testimony and analysis to the litigants in exchange for the compiler marketing their expert medical skills. The litigant pays the compiler at least an hourly rate for services provided by the professional to the litigant. The litigant may be required to pay the compiler a user fee in an online embodiment. Likewise, the professional may be required to pay to be listed in the first database. In one instance, the compiler may charge the litigant two hundred dollars ($200.00) per hour of time provided by the professional. The litigant pays the amount due to the compiler who in turn pays the amount due with the professional in an independent contracting relationship. That is, the professional is an independent contractor to the compiler.

The term “independent contractor” shall have its ordinary meaning as prescribed by the Internal Revenue Service. An independent contractor is not in an association, partnership, joint venture, or relationship of principal and agent or master and servant, or employer and employee with the compiler. Nothing provides the independent contractor with the right, power or authority, whether express or implied, to create any duty or obligation on behalf of the compiler. The independent contractor is not treated as an employee of compiler for any purpose, including for the purposes of fringe benefits provided by compiler, or for disability income, social security taxes and benefits, federal unemployment compensation taxes, state unemployment insurance benefits and federal income tax withholding at sources. The independent contractor hereby represents that she/he has and at all times maintains timely payments of all taxes due to the Internal Revenue Service and all other government agencies, including withholding and all other taxes as prescribed by law.

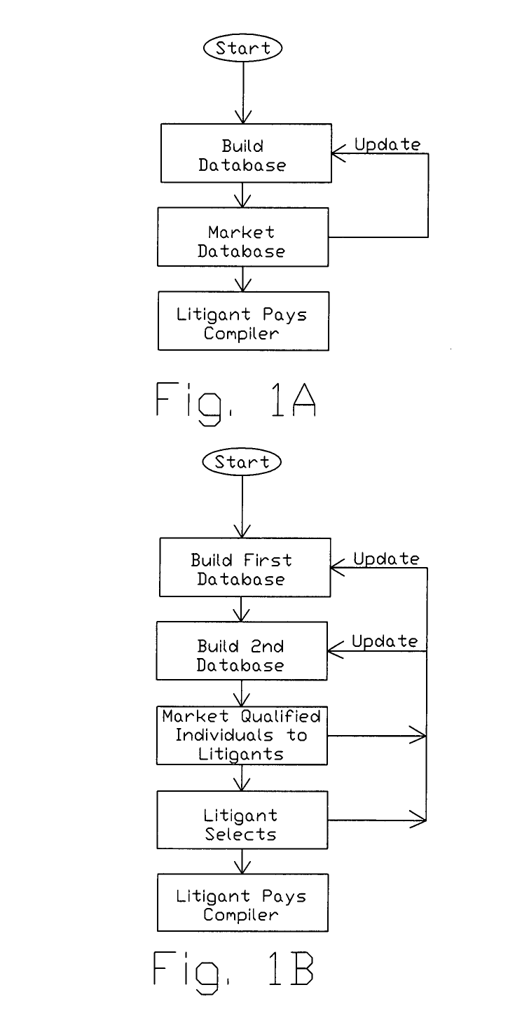

Referring now to the figures, FIG. 1A is a flowchart of the method for implementing the invention in a first embodiment. In this embodiment, the user builds a-list of licensed or qualified individuals or professionals. The list could be built in a variety of manners from marketing to students who are entering the professional field to building the list from sources such as particular employers or public databases that are hosted by a particular licensing authority. The qualified individuals, recognized for their credentials such as schooling, training and professional licensing, are professionals who work in the medical field and whose jobs require advanced knowledge in a field of science or learning customarily acquired by a prolonged course of specialized intellectual instruction, prior to entry in a job.

A compiler contacts the professionals and asks them whether they would like to perform litigation services in the way of providing expert testimony. If a professional desires to participate in the marketing of their services in rendering expert testimony, then she submits her information to the compiler who compiles the information and her work experiences into a database 10. The database 10 is built in this manner and is then marketed to prospective and actual litigants. Periodically, the database 10 is updated by the participants to include current experiences including litigated issues and outcomes of particular cases. Prior to being listed in the first database, a participant agrees to certain terms and conditions that establish the independent contracting relationship between the participants and the compiler. When a participant renders expert testimony or assistance to the litigant, the litigant then pays the compiler who in turn pays the participant for services rendered.

This particular database is more clearly shown in FIG. 5. The database 10 includes fields that list the names of the participants, their qualifications and contact information. The qualifications may include schooling such as earned degrees, work experiences and history, as well as any litigation experience and the type of litigation including specific information such as cause of action, issues litigated and outcome of litigation. Contact information may include a postal address, an email address, a telephone number and a facsimile number. The database 10 may be configured to be searchable to allow easy use. For example, a user may easily identify participants who have participated in particular causes of actions or certain drug interaction/reaction cases. All the fields of the database are configured to be searchable through the use of a program routine in a processor.

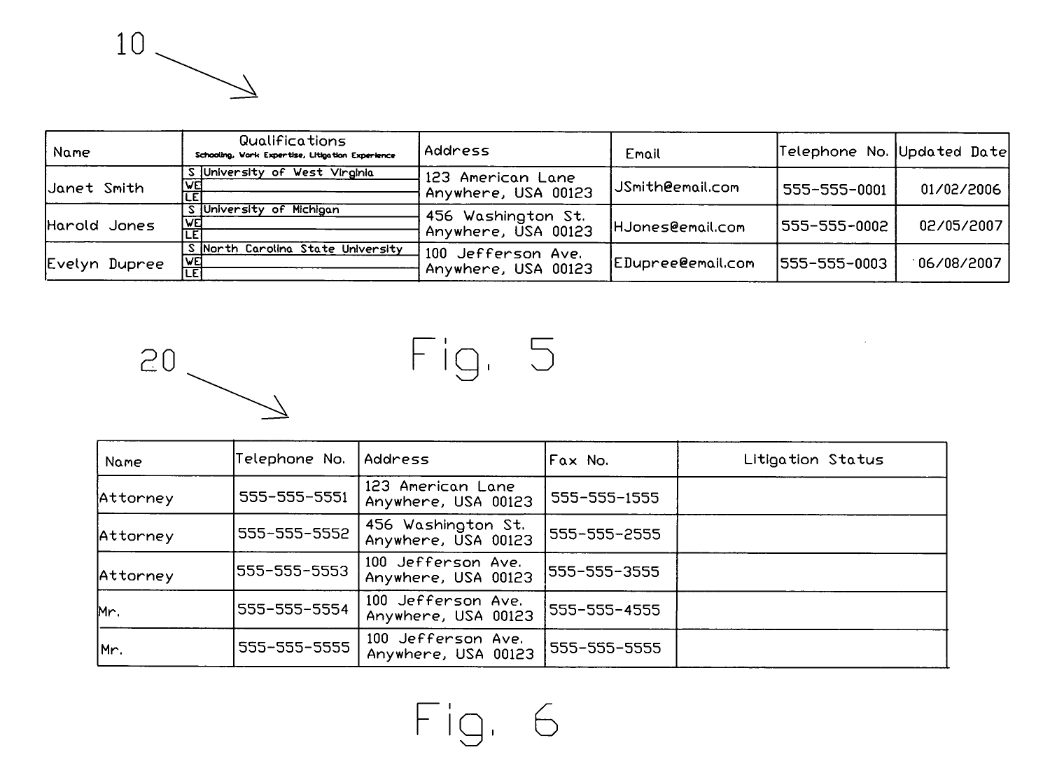

In FIG. 1B, a second database 20 is built and may include the fields shown in FIG. 6. In this embodiment, the litigant's title such as attorney or plaintiff may be compiled. This second database 20 may be compiled via public accessible records through state bar associations. Otherwise, advertisements may be placed and various individuals who are interested in purchasing the compiled data in the first database 10 may be listed in this second database 20. Either database 10, 20 may be updated periodically as shown. The first database may be updated to include a professional status in the qualifications fields of the database 10. Likewise an updated date may be included in the database 10 for indicating when the data was first compiled or last updated by either the compiler or the qualified individual. Contact information may include telephone numbers, addresses, facsimile numbers and email addresses. Litigation status of a particular case may also be associated with a qualified individual's personal data. After the databases are built, the information from the first database is marketed to the litigants listed in the second database. The litigants then choose to retain the services a particular qualified individual and retain them as an independent contractor. It should be noted that the compiler of the data or the owner of the first database may choose to charge the participants for participating in the listing of their qualifications in the first database. Likewise, it is intended that the litigants from the second database will pay to have access to the first database.

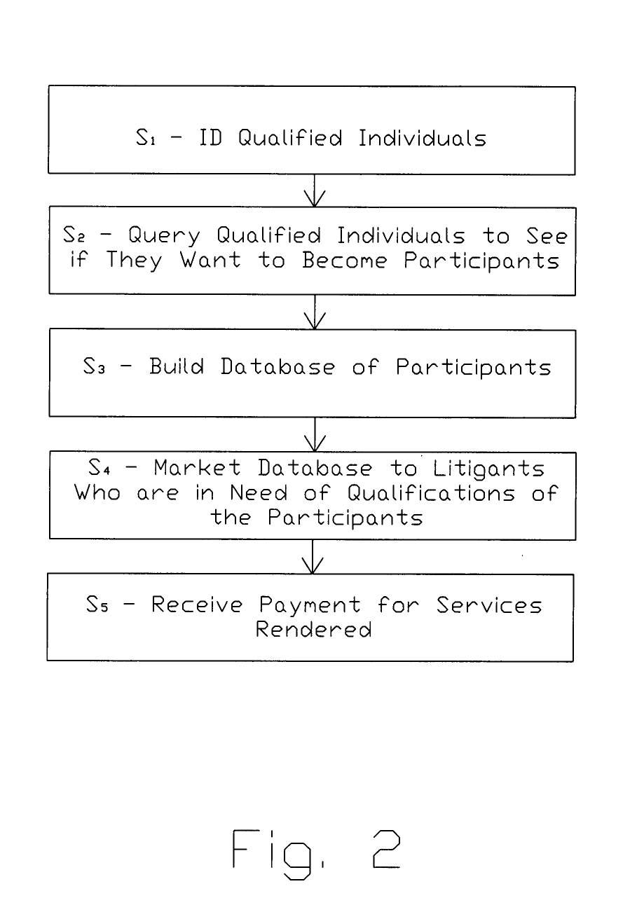

In FIG. 2 the steps are included for building the database 10. The steps include identifying professionals who are qualified to participate in the marketing process. In one instance, this includes anyone who has a license to practice pharmacy in a particular state and is in good standing with the particular governing or licensing authority. It should be noted that the system may be modified to include other medical professionals and each may be listed under a different group of compiled fields within the database. For example, one area of the database may include pharmacists, another may comprise nurse practitioners, and still another may include medical technologists.

These professional or qualified individuals are contacted and offered the chance to participate in performing expert testimony services for litigants. Upon confirmation, the participants are listed in the database 10 shown in FIG. 5. A second database 20 and shown in FIG. 6, may also be compiled. Participants of the first database are marketed to those listed in the second database. The litigants in the second database determine whether they will utilize the expert testimony services of the qualified individuals or professionals. A fee is paid by the litigants to access the information of the first database. Those listed in the first database may also pay to have their qualifications listed and marketed to the litigants in the second database.

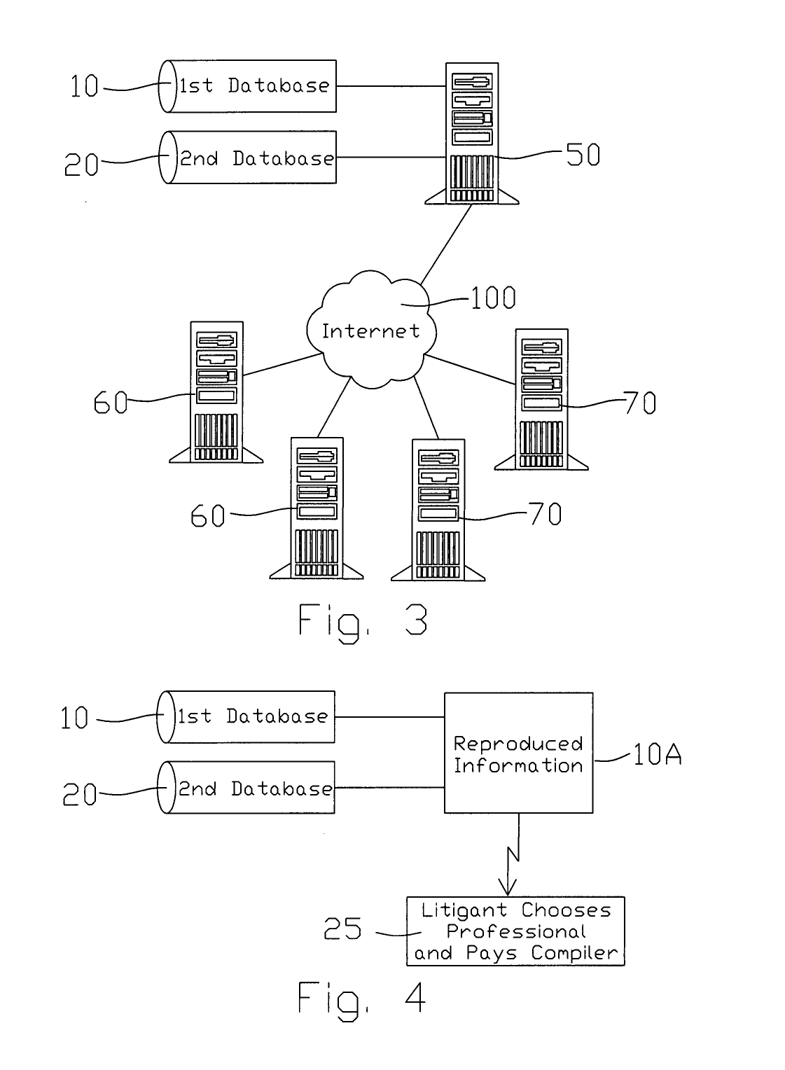

FIG. 3 is a schematic view of an online embodiment. As shown, the first and second databases 10, 20 are built. In this instance, the second database comprises paying litigants who have paid to have access to the information contained in the first database. The first database 10 is listed on a processor unit 50 which may comprise a server. The second database 20 may also be listed on the processor unit 50 and comprise paying litigants, represented by their associated processor units 60. The litigants access the processor unit 50 through their individual processor 60 and the Internet 100. Processor 50 compares a user name and password of the paying litigant to confirm an identity. If a user who contacts the processor 50 is not recognized, the processor 50 will make an offer to sell access to the unidentified user and process it through PayPal® or another online payment method. A storage medium is included in the processor 50 for compiling the data in the first and second databases as well as providing limited access to each database via passwords such that only the participants or compiler can update individual data in the first database. Likewise, only the litigant and the compiler can update information in the second database. The storage medium may also include the instructions for carrying out the necessary process steps for achieving the invention.

If the processor 50 recognizes the litigant 60 as being listed in the second database, it allows the litigant to access the first database. The members of the second database or those of the first database may remotely contact a processor that includes a memory that stores both databases. The members of the second database access information from the first database remotely through the internet. Likewise, members in the first database may periodically update their information by contacting processor 50 via their individual processor 70 and the internet 100.

FIG. 4 is a schematic view of an off-line embodiment. In this instance the first database 10 is built. Litigants listed in the second database 20 are contacted via contact information stored in the second database and are offered to purchase information listed in the first database. Information from the first database is reproduced in an additional database 10A and forwarded to the appropriate litigant. The litigant then chooses whether to retain one of the participants listed in the additional database 10A. The litigant then chooses the appropriate professional and then pays the compiler in step 25. It should be noted that various means of advertising may incorporated into the present invention. The process of marketing the first database to the second database includes one or more selected from a group consisting of email, US Postal Service, telephone calls or facsimile calls. In an online embodiment, the litigant may choose a particular participant to provide the testimonial or other requested services. In an off-line embodiment, the compiler may choose a participant for the litigant or the litigant may choose to pay to pick a particular participant to provide services to the litigant.

While the invention has been described with respect to preferred embodiments, it is intended that all matter contained in the above description or shown in the accompanying drawings shall be interpreted as illustrative and not in limiting sense. From the above disclosure of the general principles of the present invention and the preceding detailed description, those skilled in the art will readily comprehend the various modifications to which the present invention is susceptible. Therefore, the scope of the invention should be limited only by the following claims and equivalents thereof.

I claim:

1. A method for providing expert medical testimony including:
building a first database of qualified medical professionals by contacting the qualified medical professionals and querying whether they would like to participate in providing expert testimony for litigation;
marketing the first database of qualified medical professionals to litigants who are interested in obtaining expert testimony on medical matters;
selecting a qualified medical professional from the first database; and,
updating the first database to include that the qualified medical professional has participated in a particular litigated issue.

2. The method of claim 1 further comprising building a second database of litigants who are interested in selecting qualified medical professionals for use in providing expert testimony during the litigation.

3. The method of claim 1 wherein said building the first database includes contacting a licensing board and obtaining a list of all the qualified medical professionals within a state or commonwealth.

4. The method of claim 1 wherein said building the first database includes contacting the qualified medical professionals and inquiring whether they desire to be listed in the first database.

5. The method of claim 1 wherein said building the first database includes contacting one or more qualified medical professionals selected from a group consisting of a Board of Pharmacy, a Board of Physicians Assistants, a Board of Nurse Practitioners, and a Nursing Board, a Dental Association and a Commission on Certification of Physician Assistants.

6. The method of claim 1 wherein said building the second database of litigants includes contacting a state bar association and obtaining a list of all licensed attorneys within a state.

7. The method of claim 1 wherein said marketing the first database of qualified expert medical professionals to the second database of litigants includes using one or more means of communication selected from a group consisting of direct mailers, emails, telephone calls, facsimile transmissions, television commercials, radio commercials, and printed advertisements.

8. The method of claim 1 wherein the building the first database of qualified medical professionals by contacting the qualified medical professionals and querying whether they would like to participate in providing expert testimony for litigation include contacting one or more selected from a group consisting of registered or certified medical technologists, nurses, nurse practitioners, dental hygienists and physician assistants.

9. A method for providing expert medical testimony including:
building a first database of qualified medical professionals by contacting the qualified medical professionals and querying whether they would like to participate in providing expert testimony for litigation;
building a second database of litigants who are interested in selecting the qualified medical professionals for use in providing expert testimony during the litigation;
marketing the first database of qualified medical professionals to the litigants of the second database who are interested in obtaining expert testimony on medical matters;
selecting and using one of the qualified medical professionals from the first database to provide expert testimony; and,
updating the first database to include that the qualified medical professional has participated in a particular litigated issue.

10. The method of claim 9 wherein said building the first database includes contacting a licensing board and obtaining a list of all the qualified medical professionals within a state or commonwealth.

11. The method of claim 9 wherein said building the first database includes contacting the qualified medical professionals and inquiring whether they desire to be listed in the first database.

12. The method of claim 9 wherein said building the first database includes contacting one or more selected from a group consisting of a Board of Pharmacy, a Board of Physicians Assistants, a Board of Nurse Practitioners, and a Nursing Board, a Dental Association and a Commission on Certification of Physician Assistants

13. The method of claim 9 wherein said building the second database of litigants includes contacting a state bar association and obtaining a list of all licensed attorneys within a state.

14. The method of claim 9 wherein said marketing the first database of qualified expert medical professionals to the second database of litigants includes using one or more means of communication selected from a group consisting of direct mailers, emails, telephone calls, facsimile transmissions, television commercials, radio commercials, and printed advertisements.

15. The method of claim 9 wherein the building the first database of qualified medical professionals by contacting the qualified medical professionals and querying whether they would like to participate in providing expert testimony for litigation include contacting one or more selected from a group consisting of registered or certified medical technologists, nurses, nurse practitioners, dental hygienists and physician assistants.

16. A system for reducing litigation costs and reducing costs associated with litigating product liability and drug interaction/reaction claims, said system comprising:
a compiler that compiles a database of qualified medical professionals by contacting the qualified medical professionals and querying whether they would like to participate in providing expert testimony for litigation; and,
a marketing means that markets the database of qualified medical professionals to litigants, said marketing means selected from a group consisting of email, mail delivered to a physical address, telephone, facsimile and mass media.

17. The system of claim 16 wherein said database of qualified medical professionals includes one or more data fields selected from a group consisting of schooling, work experience, litigation experience, physical address, email address, telephone number and facsimile number.

18. The system of claim 17 wherein said database of qualified medical further includes a data field that indicates when data from the qualified medical professionals was last updated.
